(19) United States
(12) Patent Application Publication
(10) Pub. No.: US 2008/0248798 A1
(43) Pub. Date: Oct. 9, 2008

(54) Wireless signal receiver with antenna pointing search control

(76) Inventor: Ching-Tung Chung, Toufen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,589

(22) Filed: Apr. 3, 2007

(51) Int. Cl. H04Q 7/20

(52) U.S. Cl. 455/425

(57) ABSTRACT

A wireless signal receiver with antenna pointing search control includes a base, a rotatable antenna assembly, a rotary supporting mechanism, and a driving motor. The driving motor is controlled via an antenna pointing operation unit and a control circuit to drive the rotatable antenna assembly supported on and connected to the rotary supporting mechanism to rotate along with the rotary supporting mechanism relative to the base. The rotary supporting mechanism includes a central shaft associated with and driven by the driving motor to rotate, and a round seat associated with the central shaft to rotate along with the central shaft. When the driving motor drives the central shaft to rotate, the central shaft brings the round seat and accordingly, the rotatable antenna assembly connected to the round seat to rotate at the same time.

### FIELD OF THE INVENTION

The present invention relates to a wireless signal receiving device, and more particularly, to a wireless signal receiver with antenna pointing search control.

### BACKGROUND OF THE INVENTION

Network techniques have been extended to wireless domain. Facilities for wireless online have been set up at public places, offices, mass transit stations, and different types of compound restaurants for people to receive and transmit data via Internet at any place at any time.

The currently available wireless online technique utilizes wireless signal networking to receive and transmit signal. A wireless signal transmitter requires an antenna device and a wireless card. The wireless card is installed on a user end apparatus, such as a computer, and the antenna device for the current wireless signal transmitter is simple and manually operated to search for a better signal position and receive a signal from a transmitting end.

The antenna device in most of the currently available wireless signal transceivers includes an outer case with a simple antenna provided thereon. The simple antenna is manually moved to search for signal position, and can only provide very poor signal receiving condition without the ability to receive good wireless signal. For example, the currently widely adopted Wimax antenna module product has an antenna, the pointing of which is frequently interfered by different factors, such as antenna field shape, environmental variables, including hindrance, radio frequency (RF) refraction, and RF reflection, etc., to thereby reduce the antenna functions of receiving and transmitting signals.

Moreover, most of the currently available wireless antennas are manually instead of automatically manipulated to change their pointing in order to search for better wireless signal position, and fail to accurately indicate which position is the best wireless signal position. The conventional wireless antenna is therefore inconvenient and inaccurate for use.

It is therefore tried by the inventor to develop a wireless signal receiver with antenna pointing search control to overcome the drawbacks in the prior art.

### SUMMARY OF THE INVENTION

A primary object of the present invention is to provide a wireless signal receiver capable of automatically searching for wireless signal. For this purpose, the wireless signal receiver of the present invention is internally provided with a driving motor, so as to be driven by the driving motor to rotate and search for the best wireless signal pointing position.

Another object of the present invention is to provide a wireless signal receiver that is able to scan signal strength in a stepped manner, so as to determine the best pointing thereof. For this purpose, the wireless signal receiver of the present invention includes a stepping motor, which has a step angle in direct proportion to an input pulse rate and has highly precision resolution, so as to quickly and accurately rotate the wireless signal receiver to the best wireless signal receiving position.

A further object of the present invention is to provide a wireless signal receiver that can be easily and conveniently actuated to operate. For this purpose, the wireless signal receiver of the present invention is actuated either via a physical push key, a control key for a website window, or a computer function key to run a wireless signal scanning function and search scanning records for the best wireless signal, so as to be correctly turned to a position having the best signal strength.

To achieve the above objectives, in accordance with the present invention, a wireless signal receiver with antenna pointing search control is provided, which comprises a base, a rotatable antenna assembly, a rotary supporting mechanism, and a driving motor. The driving motor is controlled via an antenna pointing operation unit and a control circuit to drive the rotatable antenna assembly supported on and connected to the rotary supporting mechanism to rotate along with the rotary supporting mechanism relative to the base. The rotary supporting mechanism includes a central shaft associated with and driven by the driving motor to rotate, and a round seat associated with the central shaft to rotate along with the central shaft. When the driving motor drives the central shaft to rotate, the central shaft brings the round seat and accordingly, the rotatable antenna assembly connected to the round seat to rotate at the same time.

In a preferred embodiment, a stepping motor is used, which is driven to rotate clockwise within 360 degrees at a fixed step angle and produces a plurality of wireless signal strength data for comparison. As a result, a position having the best wireless signal strength may be found and the rotatable antenna assembly may be turned to point toward the best signal receiving position to create the best wireless signal receiving effect. When the wireless signal is weak or becomes weak, a user needs only to push or click on the operation key to actuate the driving motor to search again for the best signal position.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a wireless signal receiver with antenna pointing search control according to a first embodiment of the present invention;

FIG. 2 is a sectional view taken along line 2-2 of FIG. 1;

FIG. 3 shows the operation between the wireless signal receiver of the present invention and a wireless base station;

FIG. 4 is a sectional view of a wireless signal receiver with antenna pointing search control according to a second embodiment of the present invention; and

FIG. 5 shows the connection of the wireless signal receiver of the present invention to a computer.

### DETAILED DESCRIPTION OF THE PREFERRED EMBODIMENTS

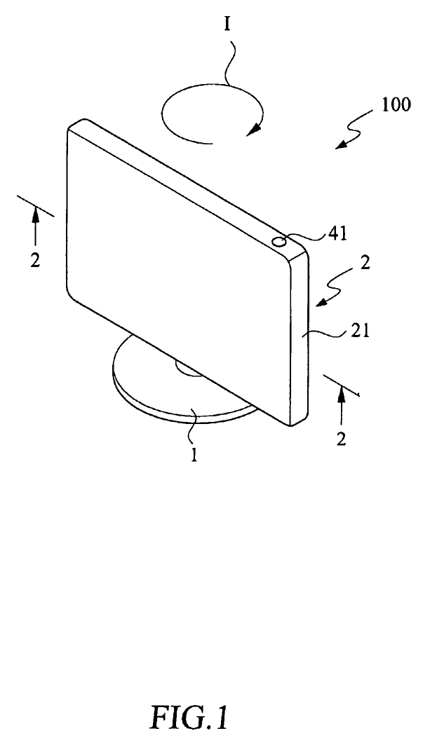

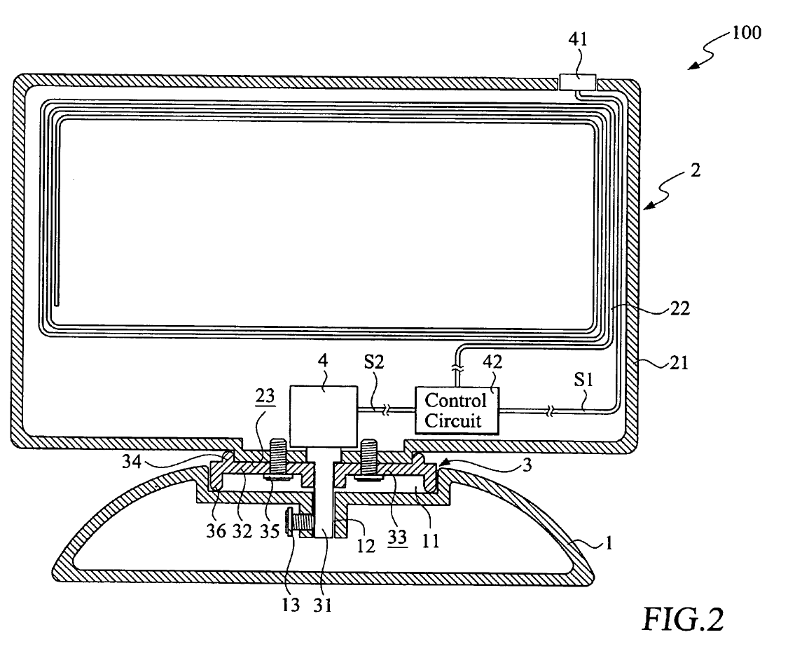

Please refer to FIGS. 1 and 2. FIG. 1 shows perspective view of a wireless signal receiver with antenna pointing search control according to a first embodiment of the present invention and FIG. 2 is a sectional view taken along line 2-2 of FIG. 1. For the purpose of conciseness, the present invention is also briefly referred to the wireless signal receiver and is generally denoted a reference numeral 100 in the first embodiment. As shown, the wireless signal receiver 100 includes a base 1, a rotatable antenna assembly 2, and a rotary supporting mechanism 3 for supporting and connecting the rotatable antenna assembly 2 to the base 1.

The base 1 is provided at a top with a recess 11, in which the rotary supporting mechanism 3 is received; and a central shaft hole 12 formed at a central area in the recess 11 of the base 1. The rotatable antenna assembly 2 includes an antenna housing 21, and an antenna coil 22 wound in the antenna housing 21. The rotary supporting mechanism 3 includes a central shaft 31 and a round seat 32.

The round seat 32 of the rotary supporting mechanism 3 is provided on a top plate 33 with an upward protruded annular locating section 34 for fitly locating around a downward protruded bottom portion 23 of the antenna housing 21. When the bottom portion 23 of the antenna housing 21 of the rotatable antenna assembly 2 is seated on the top plate 33 of the round seat 32, an outer peripheral wall of the downward protruded bottom portion 23 just bears against an inner wall surface of the annular locating section 34. The antenna housing 21 and the round seat 32 are connected to one another using fastening elements of a known type, such as screw bolts 35.

The round seat 32 is provided on an underside with a downward protruded smooth contact section 36, which is in contact with and supported on a top surface of the recess 11 of the base 1, allowing the round seat 32 to smoothly and stably rotate in and over the recess 11.

The wireless signal receiver 100 of the present invention further includes a driving motor 4 associated with the central shaft 31 of the rotary supporting mechanism 3, so that the central shaft 31 may be driven by the driving motor 4 to rotate. A lower free end of the central shaft 31 is inserted in the central shaft hole 31 at the central area of the recess 11 on the base 1, and is locked to the central shaft hole 12 with a screw bolt 13, for example.

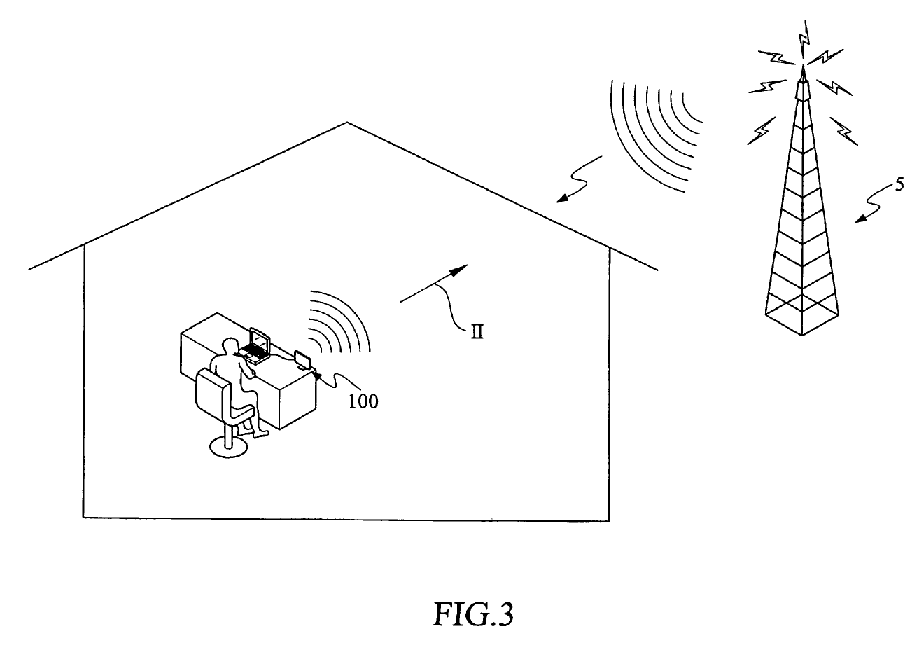

An antenna pointing operation unit 41 is arranged on the antenna housing 21 at a predetermined position, and is in the form of an operation key for a user to push. Please also refer to FIG. 3 that shows the operation between the wireless signal receiver 100 and a wireless base station 5. When the antenna pointing operation unit 41 is pushed, an operation signal S1 is generated and transmitted to a control circuit 42 in the antenna housing 21 of the rotatable antenna assembly 2, so that the control circuit 42 further generates a driving signal S2 to control the driving motor 4 to rotate in a direction I. This operation enables the rotatable antenna assembly 2 to perform a 360-degree scan of the whole site in which the wireless signal receiver 100 is located, so as to determine an angle at which the highest wireless signal strength is found. The rotatable antenna assembly 2 is then driven by the driving motor 4 to turn to the best signal receiving angle for the antenna coil 22 thereof to receive the best electromagnetic signal.

When the driving motor 4 drives the central shaft 31 of the rotary supporting mechanism 3 to rotate, since the central shaft 31 is fixed to the base 1, the antenna housing 21 of the rotatable antenna assembly 2 and the round seat 32 of the rotary supporting mechanism 3 are brought to rotate relative to the base 1.

In a preferred embodiment of the present invention, the driving motor 4 is a stepping motor, so that the rotation of the driving motor 4 may be divided into multiple steps. For example, the driving motor 4 may be set to rotate a full circle of 360 degrees in 500 steps, so as to turn 0.72 degree in each step and produce a wireless signal strength data at each step of turning. When the driving motor 4 completes turning 360 degrees, total 500 wireless signal strength data are produced.

In the case of using a stepping motor as a rotary driving means in the present invention, the step angle of the stepping motor is in direct proportion to the pulse rate output by the control circuit. Therefore, a highly precise angle and resolution may be achieved through open-loop control. The stepping motor has good response to start, stop, and forward and rearward rotation, and is easy to control. The stepping motor has small error in the step angle and has not accumulated error. The stepping motor in a still state has very high holding torque to maintain at a stably stopped position without turning freely even if no brake circuit is used.

When the antenna pointing operation unit 41 is actuated, the control circuit 42 would generate the driving signal S2 based on the received operation signal S1 generated by the antenna pointing operation unit 41, and outputs pulse to drive the driving motor 4 to rotate in a stepped manner. When the driving motor 4 starts rotating, a radio frequency (RF) chip in the control circuit 42 receives a receive signal strength value produced by a receive signal strength indicator (RSSI) whenever the driving motor 4 rotates by one step angle, and sends the received RSSI value to the control circuit 42 for comparing with a RSSI value of a preceding step angle, so that the control circuit 42 may determine which one of the received RSSI values is better. When all the RSSI values produced at each step angle within one circle of 360 degrees have been compared with a preceding value in the above manner, the control circuit 42 drives the driving motor (or stepping motor) 4 to turn to an angular position best for receiving signal, so that the rotatable antenna assembly 2 of the wireless signal receiver 100 of the present invention may be pointed toward the wireless base station 5 from a position II that has the best wireless signal strength.

To save the time for data determination, whenever the stepping motor 4 is turned to a next step angle, the RSSI value obtained thereat is immediately compared with that obtained at the preceding step angle, and a better one of the two values is selected. In the event two values obtained at two step angles are very close or identical, the preceding step angle is determined as the angular position best for receiving signal. The stepping motor 4 keeps the stepped rotation and comparison until a full turn of 360 degrees has been completed and all the RSSI values have been compared with a preceding one. In this manner, it is not necessary for the driving motor 4 to take a long time to turn back to the most desired signal position after a full circle of turning thereof.

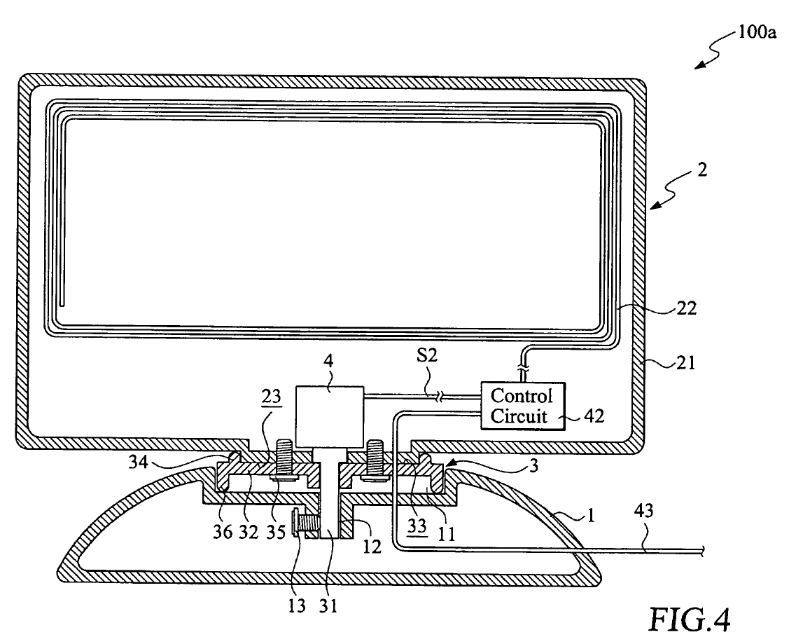

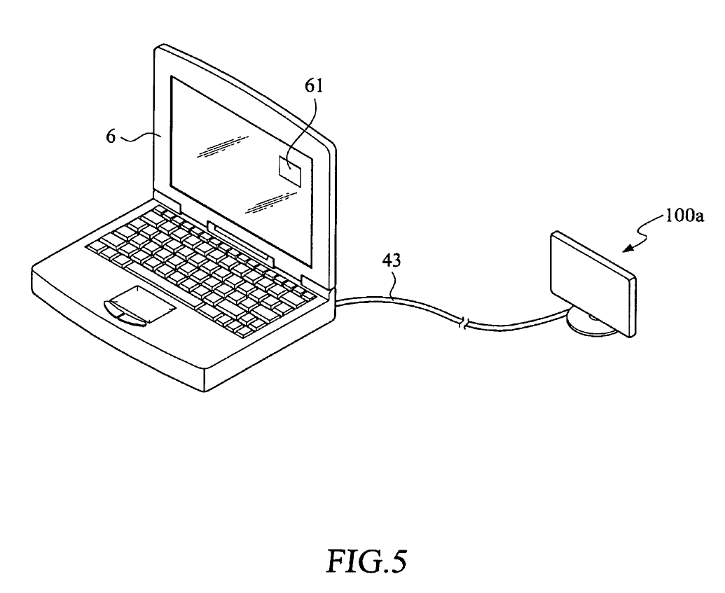

In the first embodiment, the antenna pointing operation unit 41 for controlling the wireless signal receiver 100 to the best pointing angle is a physical push key for manually operating by a user. However, there are also other ways for generating a trigger signal to achieve the same function of pointing the wireless signal receiver toward an optimal angular position for receiving a signal. FIG. 4 is a sectional view showing a wireless signal receiver with antenna pointing search control according to a second embodiment of the present invention, and FIG. 5 shows the connection of the wireless signal receiver 100a of the second embodiment to a computer apparatus 6. The wireless signal receiver 100a also includes a control circuit 42 that is connected to the computer apparatus 6 via a conventional signal transmission cable 43.

The wireless signal receiver 100a in the second embodiment is not arranged with an antenna pointing operation key. However, the computer apparatus 6 is provided at a predetermined area or in a predetermined program, such as a website window, displayed on a display of the computer apparatus 6 with a click key 61, at where a user may click for a rotatable antenna assembly 2 of the wireless signal receiver 100a to rotate and scan, so as to obtain a pointing position with best wireless signal strength. Of course, as another embodiment of the present invention, it is also possible to directly preset and use a key or a function key on a keyboard of the computer apparatus 6 as an antenna pointing operation key to replace the click key 61.

Moreover, in the above illustrated embodiments, the driving motor 4 is arranged in an internal space defined in the antenna housing 21 of the rotatable antenna assembly 2, so that the rotatable antenna assembly 2 is supported on and rotates along with the rotary supporting mechanism 3 relative to the base 1. However, one of ordinary skill in the art can easily understand the driving motor 4 may also be arranged in an inner space defined by the base 1 to rotate the rotatable antenna assembly 2 via suitable driving assembly and shaft to achieve the objects of the present invention.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A wireless signal receiver for receiving a wireless signal transmitted from a wireless base station, comprising:
a base;
a rotatable antenna assembly including an antenna housing and an antenna coil wound in the antenna housing; and
a driving motor connected to the rotatable antenna assembly for driving the rotatable antenna assembly to rotate relative to the base, so that the antenna housing of the rotatable antenna assembly is pointed toward the wireless base station.

2. The wireless signal receiver as claimed in claim 1, further comprising a rotary supporting mechanism arranged between the rotatable antenna assembly and the base, so that the rotatable antenna assembly is rotatably supported on the base via the rotary supporting mechanism.

3. The wireless signal receiver as claimed in claim 2, wherein the rotary supporting mechanism comprising:
a central shaft associated with the driving motor to be driven by the driving motor to rotate; and the central shaft having a free end inserted in a central shaft hole formed at a top central area of the base; and
a round seat associated with the central shaft to rotate along with the central shaft; the antenna housing of the rotatable antenna assembly having a bottom portion fixed to a top surface of the round seat, and the round seat being provided on an underside with a downward protruded smooth contact section, via which the rotary supporting mechanism is in contact with and supported on the base;
whereby when the driving motor drives the central shaft to rotate, the central shaft further brings the round seat and accordingly, the antenna housing of the rotatable antenna assembly to rotate.

4. The wireless signal receiver as claimed in claim 3, wherein the round seat is provided on the top surface with an upward protruded annular locating section, which fitly locates around the bottom portion of the antenna housing to hold the antenna housing in place.

5. The wireless signal receiver as claimed in claim 2, wherein the base is provided on a top with a recess, in which the rotary supporting mechanism is received.

6. The wireless signal receiver as claimed in claim 1, wherein the driving motor is a stepping motor.

7. The wireless signal receiver as claimed in claim 1, further comprising an antenna pointing operation unit.

8. The wireless signal receiver as claimed in claim 7, wherein the antenna pointing operation unit is an operation key provided on the antenna housing of the rotatable antenna assembly.

9. A wireless signal receiver for transmitting a wireless signal received from a wireless base station to a computer apparatus, comprising:
a base;
a signal transmission cable extended between and connected to the wireless signal receiver and the computer apparatus;
a rotatable antenna assembly including an antenna housing and an antenna coil wound in the antenna housing, and being associated with and rotatably supported on the base; and
a driving motor connected to the rotatable antenna assembly for driving the rotatable antenna assembly to rotate relative to the base, so that the antenna housing of the rotatable antenna assembly is pointed toward the wireless base station.

10. The wireless signal receiver as claimed in claim 9, further comprising a rotary supporting mechanism arranged between the rotatable antenna assembly and the base, so that the rotatable antenna assembly is rotatably supported on the base via the rotary supporting mechanism.

11. The wireless signal receiver as claimed in claim 10, wherein the rotary supporting mechanism comprising:
a central shaft associated with the driving motor to be driven by the driving motor to rotate; and the central shaft having a free end inserted in a central shaft hole formed at a top central area of the base; and
a round seat associated with the central shaft to rotate along with the central shaft; the antenna housing of the rotatable antenna assembly having a bottom portion fixed to a top surface of the round seat, and the round seat being provided on an underside with a downward protruded smooth contact section, via which the rotary supporting mechanism is in contact with and supported on the base;
whereby when the driving motor drives the central shaft to rotate, the central shaft further brings the round seat and accordingly, the antenna housing of the rotatable antenna assembly to rotate.

12. The wireless signal receiver as claimed in claim 11, wherein the round seat is provided on the top surface with an upward protruded annular locating section, which fitly locates around the bottom portion of the antenna housing to hold the antenna housing in place.

13. The wireless signal receiver as claimed in claim 10, wherein the base is provided on a top with a recess, in which the rotary supporting mechanism is received.

14. The wireless signal receiver as claimed in claim 9, wherein the driving motor is a stepping motor.

15. The wireless signal receiver as claimed in claim 9, further comprising an antenna pointing operation unit.

16. The wireless signal receiver as claimed in claim 15, wherein the antenna pointing operation unit is an operation key provided on the antenna housing of the rotatable antenna assembly.

17. The wireless signal receiver as claimed in claim 15, wherein the antenna pointing operation unit is a click key shown on a display of the computer apparatus.
